(19) United States
(12) Patent Application Publication
(10) Pub. No.: US 2025/0083297 A1
(43) Pub. Date: Mar. 13, 2025

(54) TOOL ORGANIZER

(71) Applicant: Jose Dominguez, West Liberty, IA (US)

(72) Inventor: Jose Dominguez, West Liberty, IA (US)

(21) Appl. No.: 18/829,756

(22) Filed: Sep. 10, 2024

Related U.S. Application Data
(60) Provisional application No. 63/581,894, filed on Sep. 11, 2023.

(51) Int. Cl. B25H 3/00

(52) U.S. Cl. CPC B25H 3/00

(57) ABSTRACT

A method and apparatus of a tool organizer is disclosed. A tool organizer may include a member with interwoven strands of cord and/or interconnected links, a closable latch with a gate for receiving and retaining a tool and an end for capturing a plurality of strands of cord and/or interconnected links, and a buckle captured by the strands of cord and/or interconnected links and having an open and closed position corresponding with an open and closed position of the member. The member may include paracord, and may include a strand in the open position and a band in the closed position. The latches may include carabiners and the tool may include a box end wrench.

### CROSS-REFERENCE TO RELATED APPLICATIONS

This application claims priority under 35 U.S.C. § 119 to provisional application Ser. No. 63/581,894 filed Sep. 11, 2023, which is incorporated by reference in their entirety.

### FIELD OF THE DISCLOSURE

The present disclosure relates to a method and device for organizing tools. More particularly, but not exclusively, the present disclosure relates to a tool organizer.

### BACKGROUND

Tool organizers are commonly used in various industries and come in an array of shapes, sizes, and styles, and serve a varying range of purposes. While a common tool organizer is a toolbox, there are various types of tool organizers available, such as tool chests, wall mounted organizers, shelf bins, compartment boxes or organizers, tool cabinets, tool bags, bucket tool organizers, tool carts, tool belts or various other devices for organizing tools or the like. Additionally, some tool organizers are designed to serve a specific purpose or to house a specific tool or tool set, such as roll-up pouches for box end wrenches.

While tool organizers are useful in housing tools and maintaining some sort of organizational structure, they are not without shortcomings that inhibit users from fully utilizing their time or easily accessing and returning tools. Wall mounted tool organizers are often large or heavy and can easily become disorganized. They often take up large amounts of space and are not entirely useful for the user depending on design limitations. For example, a steel pegboard may not be useful for aptly securing tools in place, and a wall mounted panel or rack may not have bins or hangers of appropriate size for tools or appropriately enable a user to store and access tool sets with ease.

Tool chests, tool cabinets, or similar tool organizers are also large and require ample space. Such tool organizers can also easily become disorganized as they include numerous compartments, slots, drawers and the like, which may lead to a user having to expend significant amounts of time searching for a lost or buried tool, or otherwise organizing and reorganizing the organizer.

While toolboxes and toolbags are also common and more compact, they are often designed to hold a variety of different tools and may not always be suitable for housing tool sets, such as box end wrench sets. Additionally, as toolboxes are typically not very large and are designed for compact storage, they therefore may not have adequate space for sufficient tool storage even though they are intended to house numerous tools. Toolboxes can also become easily disorganized because of the variety of tools they are designed to hold, and many times toolboxes have an odd assortment of slots, sections, dividers, or the like that are not conducive to housing tools or tool sets, or otherwise make actual organization cumbersome, which can make tools more difficult to access or locate, thus costing a user valuable time and energy. Another common tool organizer is a tool belt; however, these can be cumbersome, uncomfortable, heavy when worn, have limited space, and be obtrusive while a user is attempting to complete a task.

Roll-up pouches are traditionally used for wrenches, box end wrenches, screwdriver sets, or other various tool sets. However, roll-up pouches require a flat surface to open, and depending on the set size and pouch size, may require a large amount of space to be fully open. Roll-up pouches can also be cumbersome to move from one location to another, particularly if a user needs both hands for completing their task instead of sacrificing the use of one hand to the carriage of a tool pouch. These can also pose an issue if a user needs access to a multitude of tools without being compelled to travel between their project and the location of the tools, for instance, if a user is working on a vehicle and needs access to multiple sizes of wrenches, it can be time-consuming and problematic if the user must leave the project to retrieve a different tool or tool size each time, whereas it would be ideal for the tools to be in close proximity for a user to access. Additionally, tools can slide out of roll-up pouches, or the tools can become disorganized within them, which further wastes time and energy by a user who may have to reorganize or retrieve the tools. Further, if tools become disorganized, it can be difficult for a user to immediately determine if tools that are missing and identify which tools need replaced, and this is of particular importance if the missing tools are from a set of tools.

Wrench rings are also commonly used to hold tool sets such as box end wrenches, however, individual wrenches cannot be accessed easily as a user is required to slide all the wrenches around in order to access their desired wrench, and the user is then required to slide all the wrenches around again simply to return a wrench or tool back to its proper place in the tool set or sequence. This wastes time, energy, and causes a user frustration when a user is in the midst of completing a task. Wrench rings may also increase the difficulty in a user immediately determining a tool that may be missing from the set or make it more difficult to identify which specific tool is missing or needs replaced.

In short, the majority of tool organizers, especially for users that require a tool organizer for a set of tools, are too large, bulky, have odd compartment sizes or an odd variety thereof, can be confusing if there are designated slots for tools at a specific orientation, time consuming if they house too many tools and make it difficult to locate a tool or if they become disorganized and require maintenance to organize, and overall problematically time-consuming and frustrating for a user, particularly when a user is attempting to complete a task that requires tools in a timely manner. They may also make it more difficult for a user to determine if any tools are missing or to identify which tool needs replaced. While simple tool organizers, such as wrench rings, are smaller and enable a user to have their tool set in close proximity, such tool organizers lack egregiously in organization and force a user to expend additional time in maintaining organization of the tools as well as expend time to simply access or return the tools in their proper sequence. In addition, tools are often expensive, including tool sets, and having sufficient organization that decreases the likelihood of a tool getting lost, misplaced, or broken is crucial to a user.

While there exists tool organizers that attempt to address these shortcomings that include clips for removably securing tools, such as in U.S. PreGrant Publication 20110303715 and French Design Registration FR863565, such designs do not include or incorporate the usage of paracord in a method of making a tool organizer. Additionally, though there exists tool organizers that do include the usage of paracord, such as The King Kord Paracord Tool Holders, these tool organizers do not include or incorporate the usage of carabiners woven into a weave of paracord. Further, U.S. PreGrant Publication 20110303715 is directed towards a tool belt design, which does not address the shortcomings of tool belts previously described. While French Design Registration FR863565 also includes clips in a design more compact than that of a tool belt, these increase the problem of limited space for a full tool set as well as the problem of accessibility and fixed/limited orientation of a tool on the organizer.

While there also exists tool organizers that include chains for holding tools, such as in U.S. Pat. No. 9,894,965, these tool organizers do not include carabiners for removable attachment of box end wrenches or other various tools or tool sets, which is essential for tools that require durability in an organizer to eliminate the likelihood of a tool organizer breaking upon use. U.S. Pat. No. 9,894,965 additionally does not show organizational consistency that is crucial for storing tools, particularly in a tool set. In particular, U.S. Pat. No. 9,894,965 shows varying lengths of chain attached to a central ring of chains to be used as a wearable device, particularly as a decorative jewelry item, and not as a functional organizer for a set of tools, especially if the tools have significant weight.

It is imperative that a tool organizer be designed to address the shortcomings of the above-described tool organizers to better enable users to access and return tools with ease without sacrificing organization, space, time, or energy. Therefore, what is needed is a compact, quick-release tool organizer that enables a user to access a tool without having to rifle through or slide tools around, that further provides a satisfactory means of securing a tool without sacrificing organization, accessibility, or mobility of a tool organizer.

### SUMMARY

Therefore, it is a primary object, feature, or advantage of the present disclosure to improve over the state of the art by providing a tool organizer with features that enable a user to quickly select and access a tool.

It is a further object, feature, or advantage of the present disclosure to provide a tool organizer that enables a user to quickly and easily return a tool to its proper place.

It is a further object, feature, or advantage of the present disclosure to provide a tool organizer that is easy to manufacture.

Another object, feature, or advantage of the present disclosure is to provide a tool organizer that allows a user full and easy access to all tools on the organizer.

Another object, feature, or advantage of the present disclosure is to provide a tool organizer that allows a user to quickly and easily determine if tools are missing and to identify which tools are missing, especially if from a set.

Yet another object, feature, or advantage of the present disclosure is to provide a tool organizer that allows tools to be organized in a logical or chronological manner.

Still yet another object, feature, or advantage of the present disclosure is to provide a tool organizer that allows a user to access and return a tool to its proper place in a sequence of tools or other desired organization with ease.

It is another object, feature, or advantage of the present disclosure to provide a tool organizer that is easy to hold, maneuver, and mobilize.

It is a further object, feature, or advantage of the present disclosure to provide a tool organizer that can be easily stored, held, hung, or set down.

According to at least one aspect, a woven tool organizer is disclosed. The woven tool organizer may include a woven member having a plurality of interwoven strands of cord. The woven tool organizer may also include a closeable latch which may have a gate for removably receiving and retaining a tool and an opposing end, wherein the opposing end of the closeable latch may capture at least one of the plurality of strands of cord. The closable latch may include a carabiner, and the plurality of interwoven strands of cord may include paracord. Further, a buckle may be captured by one or more of the plurality of interwoven strands of cord, and the buckle may have an open and closed position corresponding with an open and closed position of the woven member. Further still, a woven member of a woven tool organizer may terminate in opposing ends and may include opposing mateable members of a buckle, and the woven member may include a strand in the open position and a band in the closed position. It is contemplated the tool for the tool organizer may include a box end wrench.

According to at least one other aspect, a method for a woven tool organizer is disclosed. The method may include providing a plurality of interwoven strands of cord, weaving the plurality of interwoven strands of cord into a woven member, capturing a portion of a closeable latch with at least one of the plurality of strands of the woven cord, and capturing a portion of a buckle with one or more of the plurality of interwoven strands of cord. The plurality of interwoven strands of cord may include paracord. The closeable latch in the method for a woven tool organizer may have a gate for removably receiving and retaining a tool and an opposing end with the portion of the closeable latch, and the closeable latch may include a carabiner. The method may further include opening the buckle for providing a woven strand of the woven member and closing the buckle for providing a woven band of the woven member. The woven member may terminate in opposing ends which may include opposing mateable members of the buckle. The method may further include removably securing a plurality of tools such as box end wrenches to the woven member with a plurality of the closeable latches and may also include removably storing a plurality of incrementally sized tools such as box end wrenches in incremental order along the woven member.

According to still another aspect, a tool organizer is disclosed. A tool organizer may include a chain member having a plurality of interconnected links, a closeable latch having a gate for removably receiving and retaining a tool and an opposing end, wherein the opposing end of the closeable latch captures at least one of a plurality of interconnected links, and a buckle captured by one or more of the plurality of interconnected links. The buckle of the tool organizer may have an open and closed position corresponding with an open and closed position of the chain member, and the chain member may terminate in opposing ends which may include opposing mateable members of the buckle. Further, the closable latch of a tool organizer may include a carabiner, and the plurality of interconnected links may include chain links. Further still, the chain member of a tool organizer may include a strand in the open position and a band in the closed position. It is contemplated that the tool for the tool organizer may be a box end wrench.

According to yet another aspect, a method for a tool organizer is disclosed. The method may include providing a chain having a plurality of interconnected links, capturing a portion of a closeable latch with at least one of the plurality of interconnected links of the chain, wherein the closeable latch has a gate for removably receiving and retaining a tool and an opposing end with the portion of the closeable latch, and capturing a portion of a buckle with one or more of the plurality of interconnected links of the chain. The closable latch may include a carabiner, and the plurality of interconnected links may include chain links. The method may further include opening the buckle for providing a chain strand of the chain and closing the buckle for providing a chain band of the chain, and the chain may terminate in opposing ends which may include opposing mateable members of the buckle. Further still, the method may include removably securing a plurality of tools such as box end wrenches to the chain with a plurality of the closeable latches and removably storing a plurality of incrementally sized tools such as box end wrenches in incremental order along the chain.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein.

FIG. 1 illustrates a perspective view of an exemplary woven tool organizer of the present disclosure.

FIG. 2 illustrates another perspective view of an exemplary woven tool organizer of the present disclosure.

FIG. 3 illustrates a perspective view of an exemplary woven tool organizer of the present disclosure in use.

FIG. 4 illustrates a perspective view of an exemplary tool organizer of the present disclosure.

FIG. 5 shows a flowchart illustrating a method for a woven tool organizer in accordance with an illustrative aspect of the present disclosure.

FIG. 6 shows another flowchart illustrating a method for a tool organizer in accordance with an illustrative aspect of the present disclosure.

### DETAILED DESCRIPTION

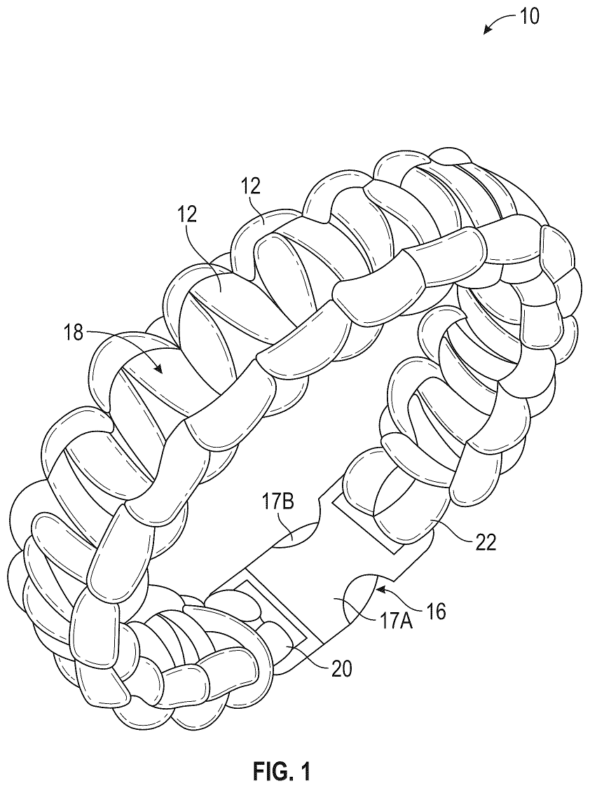

FIGS. 1-6 provide various pictorial illustrations for exemplary aspects of a tool organizer in accordance with the objects, features, and advantages of the present disclosure.

The present disclosure contemplates many different apparatuses and varying arrangements, methods and systems for a tool organizer as well as commercialization and use. Representative applications of methods and systems are described in this section as well as apparatus mechanisms and structures. These examples are provided solely to add context and aid in understanding of the described aspects of the disclosure. It will thus be apparent to one skilled in the art that the described aspects of the disclosure may be practiced without some and/or all of these specific details. In other instances, well known process steps have not been described in detail in order to avoid unnecessarily obscuring the described aspects. Other applications are possible, such that the following examples should not be taken as limiting.

In the following detailed description, references are made to the accompanying drawings, which form a part of the description and show, by way of illustration, specific aspects in accordance with the methods and systems of the present disclosure. Although aspects of the disclosure are described in sufficient detail to enable one skilled in the art to practice the described aspects, it is understood that these examples are not limiting; other aspects may be used, and changes may be made without departing from the spirit and scope of the described aspects of the disclosure.

It will also be understood that, although the terms first, second, next, lastly, etc. may be used herein to describe various elements, these elements should not be limited by such terms. These terms are only used to distinguish one element from another. For example, a first step could be termed a second step, and, similarly, a second step could be termed a first step, without departing from the spirit and scope of the present disclosure.

The terminology used herein is for the purpose of describing particular aspects of the disclosure only and is not intended to be limiting of the present disclosure. As used in the description of the apparatus, system, and method as well as the appended claims, the singular forms “a”, “an” and “the” are intended to include the plural forms as well, unless the context clearly indicates otherwise. By way of example only, while the singular form of numerous components and steps are described in various aspects of the disclosure herein, it will be apparent that more than one of such components and/or steps can be used to accomplish the same. It will also be understood that the term “and/or” as used herein refers to and encompasses any and all possible combinations of one or more of the associated listed items. It will be further understood that the terms “comprises” and/or “comprising,” when used in this specification, specify the presence of stated features, functions, integers, steps, operations, elements, and/or components, but do not preclude the presence and/or addition of one or more other features, integers, steps, operations, elements, components, and/or groups thereof. It will be similarly understood that the terms “including,” “include,” “includes”, “such as” and the like, when used in this specification, are intended to be exemplary and should be construed as including, but not be limited to, all items recited thereafter. As used herein, the term “if”' may be construed to mean “when” or “upon” or “in response to determining” or “in response to detecting,” depending on the context.

As used herein, the term “tool” is preferred to include a wrench or a box end wrench. However, it is contemplated that other tools or tool sets may be included. By way of example, it is contemplated that any type of tool, including tool sets that may be organized or secured to an organizational device may be used, such as any type of wrench including but not limited to box wrenches, ratchet wrenches, adjustable wrenches, monkey wrenches, combination wrenches, crowfoot wrenches, socket wrenches, or any other appropriate wrench. It is further contemplated that tools or various items such as but not limited to scissors, nuts, washers, or any other appropriate item or device may be used. Further still, tools from various other industries may be included, for example, camping tools and gear, sewing tools, carpentry tools, mechanic tools, fishing tools or gear, cooking tools or utensils, leathercraft or leather working tools, gardening or horticulture tools, or any other type of tools or gear from any industry may be included.

As used herein, the term “latch” is preferred to include a carabiner, such as a 2 inch by ½ inch aluminum carabiner, or any other size or material. However, it is contemplated that any other latch may be included. By way of example, it is contemplated that any other mechanism or device may be used, including but not limited to ring clasps, spring snap links, links, closable hooks, clips, magnets, or any other device or mechanism suitable for securing to another object or material.

As used herein, the term “buckle” is preferred to include a side release buckle such as a ⅝ by 1 inch side release clip buckle. However, it is contemplated that other enclosable or mateable devices or materials may be used, including but not limited to clasps, latches, hooks, rings clasps, clips, buttons, links, magnets, quick release buckles, side release buckles, buckles of any kind, or any other type of fastener that may be mated or secured together. A buckle may also include a variety of materials including but not limited to plastic, metal such as aluminum or any other metal, acrylonitrile butadiene styrene (ABS), wood, nylon, fabric, or any other suitable material or combination thereof. It is further contemplated that a buckle may be any size or shape.

FIG. 1 illustrates a perspective view of an exemplary woven tool organizer 10 of the present disclosure. Woven tool organizer 10 may include a woven member 18 having a plurality of interwoven strands of cord 12. Interwoven strands of cord 12 may be knotted, braided, weaved, knitted, twisted, crocheted, plaited, or intertwined together in any other contemplatable manner. While a single or plurality of interwoven strands of cord 12 may include paracord, it is contemplated that any other material or combination thereof may be included. For example, one strand of interwoven cord may be paracord and another strand of interwoven cord may be twine. Other materials such as rope, ribbon, yarn, wire, string, leather strips or strips of other fabric or materials, nylon, rubber, rubber bands, metal, plastic, cloth, or any other material suitable for intertwining may be utilized. It is further contemplated that materials of varying sizes may be used, for example, a combination of ⅜ inch ribbon may be used in combination with 0.16 inch Type III 7 strand paracord, which materials may be of varying colors and color combinations.

As further shown in FIG. 1, interwoven strands of cord 12 may create a woven member 18 which may terminate in opposing ends 20 and 22 and opposing mateable members 17A, 17B of a buckle 16 may be captured by one or more of the plurality of interwoven strands of cord 12 at respective opposing ends 20 and 22 of woven tool organizer 10. Buckle 16 may have an open and closed position corresponding with opposing mateable members 17A, 17B being connected and disconnected and further corresponding with an open and closed position of the woven member 18 in accordance with opposing mateable ends 20 and 22. Thus, woven member 18 may include strands of cord 12 in the open position such as when the buckle 16 is in an open position (e.g., opposing mateable members 17A, 17B are disconnected) and a band in the closed position, such as when the buckle 16 is in the closed position (e.g., opposing mateable members 17A, 17B are connected). Further, woven member 18 may be considered in an open position when opposing mateable members 17A, 17B of buckle 16 are unmated or in the open position, and woven member 18 may be considered in a closed band position when opposing mateable members 17A, 17B of buckle 16 are mated or in the closed mated position.

While woven tool organizer 10 may include a buckle 16, it is further contemplated that other enclosable or mateable devices or materials may be utilized, including but not limited to clasps, latches, hooks, rings clasps, clips, buttons, links, magnets, quick release buckles, side release buckles, buckles of any kind, or any other type of fastener that may be mated or secured together. A buckle 16 may also include a variety of materials including but not limited to plastic, metal such as aluminum or any other metal, acrylonitrile butadiene styrene (ABS), wood, nylon, fabric, or any other suitable material. It is further contemplated that buckle 16 may be of any size or shape, for example buckle 16 may be a ⅝ by 1 inch side release clip buckle.

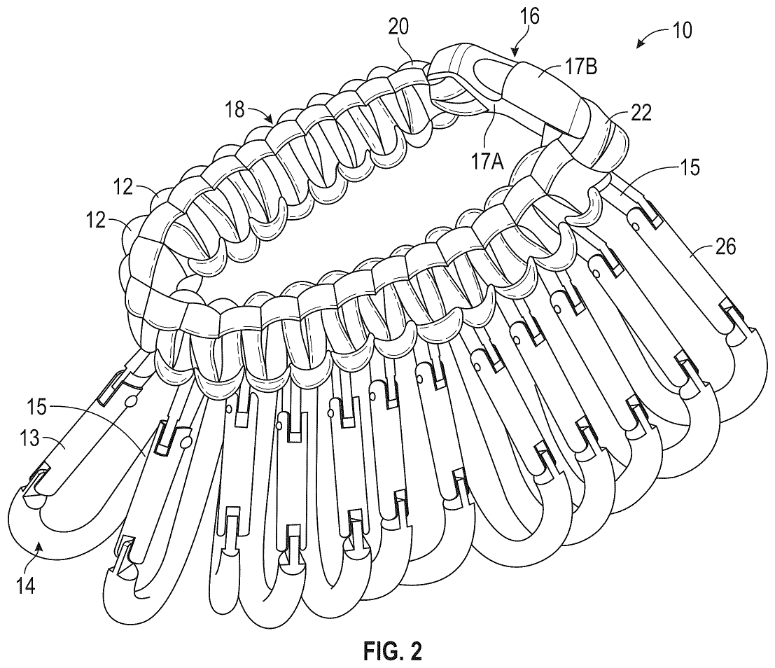

As shown in FIG. 2, woven tool organizer 10 may also include a closeable latch 14 which may have a gate 13 for removably receiving and retaining a tool 24 and an opposing end 15, wherein opposing end 15 of closeable latch 14 may capture at least one of the plurality of strands of cord 12. Closable latch 14 may include a carabiner 26, such as a 2 inch by ½ inch aluminum carabiner (or any other metal or plastic carabiner). However, it is contemplated that any other mechanism or device may be used, including but not limited to ring clasps, spring snap links, links, closable hooks, clips, or any other device or mechanism suitable for securing to woven member 18 or strands of cord 12. Closeable latch 14 may also include a variety of materials including but not limited to metal such as aluminum or any other metal, plastic or acrylic, ABS, wood, nylon, or any other suitable material.

While FIG. 2 depicts a single buckle 16 or a buckle 16 may include opposing mateable ends 17A, 17B. It is further contemplated that opposing mateable end 17A of one end of woven member 18 may be connected to opposing mateable end 17B of an opposing end of woven member 18 to allow for an increase in the length of woven member 18 and increase the capacity for incorporating latches 14 into woven member 18 and increase the overall size and capacity of woven tool organizer 10. The expanded woven tool organizer 10 may then include multiple buckles 16 for customizable length and capacity. Thus, multiple woven members 18 may be connected by a plurality of buckles 16 and may provide a longer woven member 18 and a larger tool organizer 10 with increased capacity. Tool organizer 10 with multiple woven members 18 may then enable a user to combine and include multiple varying tools 24 or sets of tools 24 onto a single member 18 or tool organizer 10.

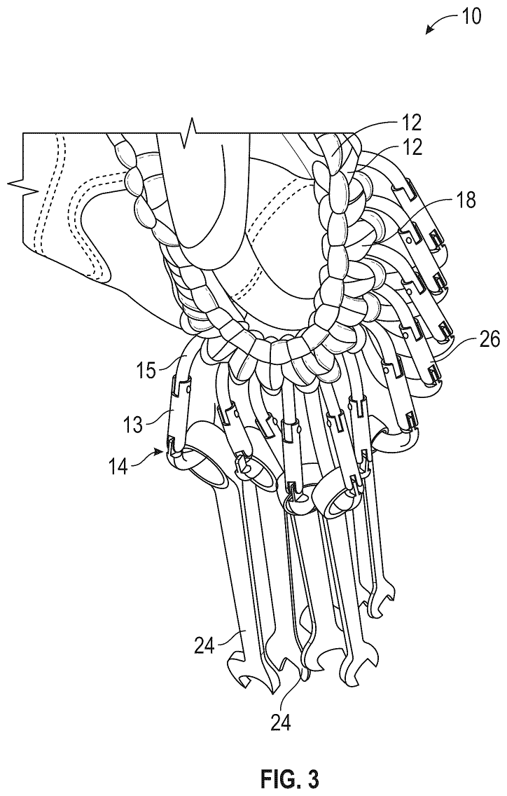

Tool 24, as shown in FIG. 3, may include a box end wrench. However, it is contemplated that various other tools may be included, such as, for example box wrenches, ratchet wrenches, adjustable wrenches, monkey wrenches, combination wrenches, crowfoot wrenches, socket wrenches, or any other appropriate wrench. It is further contemplated that tools or various items or tools may be included such as but not limited to scissors, nuts, washers, or any other item that may be secured to an organizational device. Further still, tools from various other industries may be utilized, for example, camping tools and gear, sewing tools, carpentry tools, mechanic tools, fishing tools or gear, cooking tools or utensils, leathercraft or leather working tools, gardening or horticulture tools, or any other type of tools or gear from any industry may be included. Tool 24 may be removed from a latch 14 by means of gate 13 designed for enabling an item to be removed from the latch 14, and tool 24 may be returned or secured to latch 14 through the same gate 13 while end 15 may hold latch 14 secure on tool organizer 10.

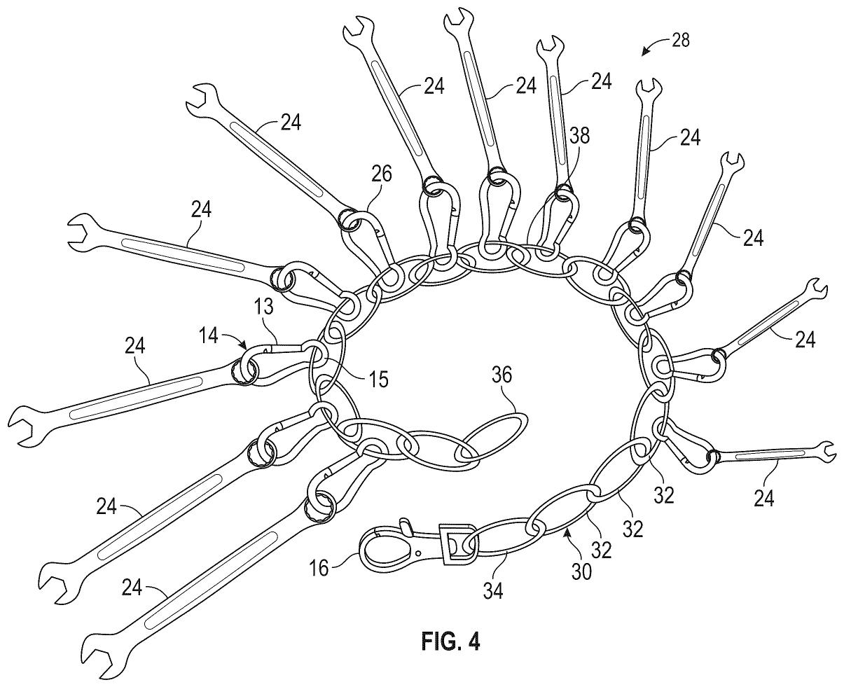

FIG. 4 illustrates a perspective view of an exemplary tool organizer 28 of the present disclosure. As shown, tool organizer 28 may include a chain member 30 having a plurality of interconnected links 32, a closeable latch 14 having a gate 13 for removably receiving and retaining a tool and an opposing end 15, wherein opposing end 15 of closeable latch 14 captures at least one of a plurality of interconnected links 32. Closable latch 14 of tool organizer 28 may include a carabiner 26, such as a 2 inch by ½ inch aluminum carabiner (or any other metal or plastic carabiner). However, it is contemplated that any other mechanism or device may be used, including but not limited to ring clasps, spring snap links, links, closable hooks, clips, or any other device or mechanism suitable for securing to link 32. Closeable latch 14 may also include a variety of materials including but not limited to metal such as aluminum or any other metal, plastic or acrylic, ABS, wood, nylon, or any other suitable material, which materials may vary in color and color combinations.

Tool 24, as shown in FIG. 4, may include a box end wrench. However, it is contemplated that various other tools may be included, such as, for example box wrenches, ratchet wrenches, adjustable wrenches, monkey wrenches, combination wrenches, crowfoot wrenches, socket wrenches, or any other appropriate wrench. It is further contemplated that tools or various items or tools may be included such as but not limited to scissors, nuts, washers, or any other item that may be secured to an organizational device. Further still, tools from various other industries may be utilized, for example, camping tools and gear, sewing tools, carpentry tools, mechanic tools, fishing tools or gear, cooking tools or utensils, leathercraft or leather working tools, gardening or horticulture tools, or any other type of tools or gear from any industry may be included. Tool 24 may be removed from a latch 14 by means of gate 13 designed for enabling an item to be removed from the latch 14, and tool 24 may be returned or secured to latch 14 through the same gate 13 while end 15 may hold the latch 14 secure on one of interconnected links 32 of tool organizer 28.

The plurality of interconnected links 32 may include chain links 38, however, it is contemplated that interconnected links 32 may include section chain, connectable hooks, rings, latches, loops, clips, clasps, or anything that may be interconnected. It is further contemplated that the interconnected links 32 may include a variety of materials or combinations thereof, including but not limited to metals such as aluminum or any other metal, rubber, plastic, acrylic, nylon, wood, ceramic, fabric, or any other suitable material. It is additionally contemplated that interconnected links 32 may include various sizes and combinations thereof. For example, interconnected links 32 may include an 8-inch aluminum section chain. Links 32 may also be permanently connected or welded together or otherwise removably connected for increasing or decreasing the length of a chain member 30 of tool organizer 28. Furthermore, chain member 30 of tool organizer 28 may include a strand in the open position as shown, for example, in FIG. 4 and a band in the closed position where a buckle 16 is removably attached to an opposing end 36 of chain member 30.

A buckle 16 may be captured by one or more of the plurality of interconnected links 32. Buckle 16 of the tool organizer 28 may have an open and closed position corresponding with an open and closed position of chain member 30, and chain member 30 may terminate in opposing ends 34 and 36 which may include opposing mateable members of buckle 16. As shown in FIG. 4, buckle 16 may include a clasp fastener, however, it is contemplated that any other enclosable or mateable devices or materials may be utilized, including but not limited to latches, hooks, rings clasps, clips, buttons, magnets, links, quick release buckles, side release buckles, buckles of any kind or any other type of fastener that may be mated or secured together.

While FIG. 4 depicts a single buckle 16, it is further contemplated that buckle 16 of tool organizer 28 may be connected to member 30 of another tool organizer 28 to increase the overall length of member 30 and increase the capacity for incorporating latches 14 into member 30 and increase the overall size and capacity of tool organizer 28. The expanded tool organizer 28 may then include multiple buckles 16 for customizable length and capacity. Thus, multiple members 30 may be connected by a plurality of buckles 16 and may provide a longer member 30 and a larger tool organizer 28 with increased capacity. Tool organizer 28 with multiple members 30 may then enable a user to combine and include multiple varying tools 24 or sets of tools 24 onto a single member 30 or tool organizer 28.

It is contemplated that tool 24 for tool organizer 28 may be a box end wrench, as previously shown in FIG. 3. However, it is contemplated that various other tools may be included, such as, for example box wrenches, ratchet wrenches, adjustable wrenches, monkey wrenches, combination wrenches, crowfoot wrenches, socket wrenches, or any other appropriate wrench. It is further contemplated that tools or various items or tools may be included such as but not limited to scissors, nuts, washers, or any other item that may be secured to an organizational device. Further still, tools from various other industries may be utilized, for example, camping tools and gear, sewing tools, carpentry tools, mechanic tools, fishing tools or gear, cooking tools or utensils, leathercraft or leather working tools, gardening or horticulture tools, or any other type of tools or gear from any industry may be included. Tool 24 may be removed from a latch 14 by means of a gate 13 designed for enabling an item to be removed from latch 14, and tool 24 may be returned or secured to latch 14 through the same gate 13 while end 15 may hold latch 14 secure on the tool organizer 28.

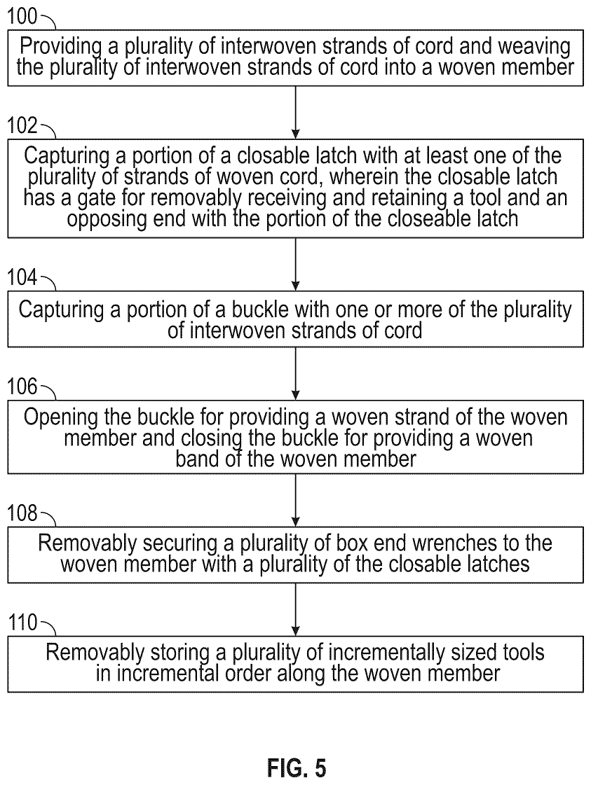

FIG. 5 shows a flowchart illustrating a method for a woven tool organizer 10 in accordance with an illustrative aspect of the present disclosure. The method may include providing a plurality of interwoven strands of cord 12 and weaving the plurality of interwoven strands of cord 12 into a woven member 18 (Step 100), capturing a portion of a closeable latch 14 with at least one of the plurality of strands of woven cord 12, wherein the closable latch 14 has a gate 13 for removably receiving and retaining a tool 24 and an opposing end 15 with the portion of the closable latch 14 (Step 102), capturing a portion of a buckle 16 with one or more of the plurality of interwoven strands of cord 12 (Step 104), opening the buckle 16 for providing a woven strand of the woven member 18 and closing the buckle 16 for providing a woven band of the woven member 18 (Step 106), removably securing a plurality of box end wrenches 24 to the woven member 18 with a plurality of the closeable latches 14 (Step 108), and/or removably storing a plurality of incrementally sized tools 24 in incremental order along the woven member 18 (Step 110). The closeable latch 14 in the method for a woven tool organizer 10 may have a gate 13 for removably receiving and retaining a tool and an opposing end 15 with the portion of the closeable latch 14, and the closeable latch may include a carabiner 26. The woven member 18 of the method may terminate in opposing ends 20 and 22 which may include opposing mateable members of the buckle 16. The plurality of interwoven strands of cord 12 may include paracord.

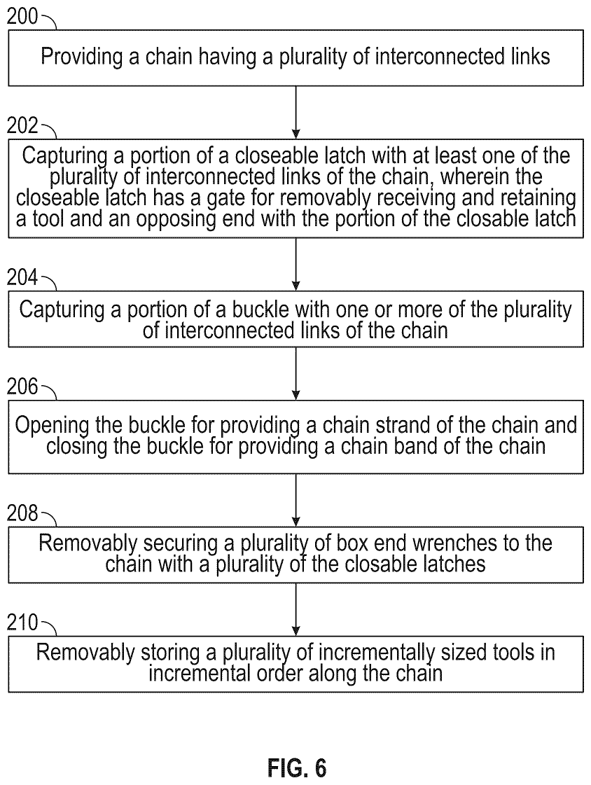

FIG. 6 shows another flowchart illustrating a method for a tool organizer 28 in accordance with an illustrative aspect of the present disclosure. The method may include providing a chain 30 having a plurality of interconnected links 32 (Step 200), capturing a at least one of the plurality of interconnected links 32 of the chain 30 with a portion of a closeable latch 14, wherein the closeable latch 14 has a gate 13 for removably receiving and retaining a tool 24 and an opposing end 15 with the portion of the closeable latch 14 (Step 202), capturing a portion of a buckle 16 with one or more of the plurality of interconnected links 32 of the chain 30 (Step 204), opening the buckle 16 for providing a chain strand (e.g., by disconnecting opposing mateable ends 17A, 17B or disconnecting buckle 16 from one of interconnecting links 32) of the chain 30 and closing the buckle 16 (e.g., by connecting opposing mateable ends 17A, 17B or connecting buckle 16 to one of interconnecting links 32) for providing a chain band of the chain 30 (Step 206), removably securing a plurality of tools 24 such as box end wrenches to chain 30 with a plurality of the closeable latches 14 (Step 208), and/or removably storing a plurality of incrementally sized tools 24 in incremental order along the chain 30 (Step 210). Closable latch 14 may be a carabiner 26, and the plurality of interconnected links 32 may be chain links 38. The chain 30 may terminate in opposing ends 34 and 36 which may include opposing mateable members ends 17A, 17B of buckle 16.

The disclosure is not to be limited to the particular aspects described herein. In particular, the disclosure contemplates numerous variations in a tool organizer. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes or methods of the disclosure. It is understood that any other modifications, substitutions, and/or additions can be made, which are within the intended spirit and scope of the disclosure.

1. A woven tool organizer, comprising:
a woven member having a plurality of interwoven strands of cord;
a closeable latch having a gate for removably receiving and retaining a tool and an opposing end, wherein the opposing end of the closeable latch captures at least one of the plurality of strands of cord;
a buckle captured by one or more of the plurality of interwoven strands of cord.

2. The tool organizer of claim 1, wherein the buckle has an open and closed position corresponding with an open and closed position of the woven member.

3. The tool organizer of claim 1, wherein the woven member terminates in opposing ends comprising opposing mateable members of the buckle.

4. The tool organizer of claim 1, wherein the closeable latch comprises a carabiner.

5. The tool organizer of claim 1, wherein the plurality of interwoven strands of cord comprise paracord.

6. The tool organizer of claim 2, wherein the woven member comprises a strand in the open position and a band in the closed position.

7. The tool organizer of claim 1, wherein the tool comprises a box end wrench.

8. A method for a woven tool organizer, comprising:
providing a plurality of interwoven strands of cord;
weaving the plurality of interwoven strands of cord into a woven member;
capturing a portion of a closeable latch with at least one of the plurality of strands of the woven cord, wherein the closeable latch has a gate for removably receiving and retaining a tool and an opposing end with the portion of the closeable latch;
capturing a portion of a buckle with one or more of the plurality of interwoven strands of cord.

9. The method of claim 8 further comprising:
opening the buckle for providing a woven strand of the woven member and closing the buckle for providing a woven band of the woven member.

10. The method of claim 8, wherein the woven member terminates in opposing ends comprising opposing mateable members of the buckle.

11. The method of claim 8, wherein the closeable latch comprises a carabiner.

12. The method of claim 8, wherein the plurality of interwoven strands of cord comprise paracord.

13. The method of claim 8, further comprising:
removably securing a plurality of box end wrenches to the woven member with a plurality of the closeable latches.

14. The method of claim 8, further comprising:
removably storing a plurality of incrementally sized tools in incremental order along the woven member.

15. A tool organizer, comprising:
a chain member having a plurality of interconnected links;
a closeable latch having a gate for removably receiving and retaining a tool and an opposing end, wherein the opposing end of the closeable latch captures at least one of the plurality of interconnected links;
a buckle captured by one or more of the plurality of interconnected links.

16. The tool organizer of claim 15, wherein the buckle has an open and closed position corresponding with an open and closed position of the chain member.

17. The tool organizer of claim 15, wherein the chain member terminates in opposing ends comprising opposing mateable members of the buckle.

18. The tool organizer of claim 15, wherein the closeable latch comprises a carabiner.

19. The tool organizer of claim 15, wherein the plurality of interconnected links comprise chain links.

20. The tool organizer of claim 16, wherein the chain member comprises a strand in the open position and a band in the closed position.
